(19) United States
(12) Patent Application Publication
(10) Pub. No.: US 2011/0254305 A1
(43) Pub. Date: Oct. 20, 2011

(54) Slide-out

(76) Inventor: Michael Gogola, South Bend, IN (US)

(21) Appl. No.: 12/799,178

(22) Filed: Apr. 20, 2010

(51) Int. Cl. B62D 21/14

(52) U.S. Cl. 296/26.13

(57) ABSTRACT

A vehicle slide out comprising a pair of first members mountable parallel to each other within a towed vehicle frame, a pair of second members, each cooperatively engaged with a respective first member, each second member having a plurality of holes disposed lengthwise along a side, a motive member serially engageable with the plurality of holes, a threaded member connected to the second member and having a proximal threadably adjustable first stop and a distal threadably adjustable second stop, a position of the first stop and the second stop adjustable by an adjuster disposed at a proximal end of the threaded member, and the first stop and the second stop disposed to contact the towed vehicle frame.

### FIELD OF THE INVENTION

The invention relates to a slide-out, and more particularly, to a vehicle slide out room mechanism comprising a threadably adjustable movement limiter which is accessible from a proximal end.

### BACKGROUND OF THE INVENTION

Vehicles (including self-powered vehicles and non-powered trailers) having interiors with living space, such as recreational vehicles (RVs), are well-known. In order to increase the interior living space available in such vehicles it is known to have slide-out sections, such as rooms and closets, that can be retracted during transit and extended when the vehicle is stationary and intended to be occupied. To use the slide-out section, the vehicle is first parked and leveled and then the slide-out section is extended by a manual or powered slide-out assembly. With the slide-out section extended outward from the vehicle, the interior space can be significantly increased.

Stops are used to adjust the room so that the seal is properly seated in the in or out position.

The range of movement of the slide-out section is generally limited by simple mechanical interferences or by limit switches. Either system can only be adjusted by accessing the underside of the trailer which can be difficult, time consuming and can damage the trailer.

Representative of the art is U.S. Pat. No. 7,234,758 which discloses a gear operated pivoting travel lock secures a slide-out section of a vehicle in a retracted position. The travel lock includes a gear box, containing two mating worm gears, that mounts to a wall of the slide-out section. The drive gear is mounted at the end of an operating member and the driven gear is mounted to an axle. Two pivot arms are mounted at the ends of the axle. Turning the operating member, preferably by a handle member, rotates the drive gear to mesh with the driven gear. As the driven gear rotates, the pivot arms swing out from a collapsed position to an engaged position. When the slide-out section is retracted within the vehicle, a pressure pad at the end of the pivot arms clamps against an interior surface of the vehicle wall. When the travel lock is collapsed the slide-out section can be moved between the retracted and extended positions.

What is needed is a vehicle slide out room mechanism comprising a threadably adjustable movement limiter which is accessible from a proximal end. The present invention meets this need.

### SUMMARY OF THE INVENTION

The primary aspect of the invention is to provide a vehicle slide out room mechanism comprising a threadably adjustable movement limiter which is accessible from a proximal end.

Other aspects of the invention will be pointed out or made obvious by the following description of the invention and the accompanying drawings.

The invention comprises a vehicle slide out comprising a pair of first members mountable parallel to each other within a towed vehicle frame, a pair of second members, each cooperatively engaged with a respective first member, each second member having a plurality of holes disposed lengthwise along a side, a motive member serially engageable with the plurality of holes, a threaded member connected to the second member and having a proximal threadably adjustable first stop and a distal threadably adjustable second stop, a position of the first stop and the second stop adjustable by an adjuster disposed at a proximal end of the threaded member, and the first stop and the second stop disposed to contact the towed vehicle frame.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a perspective view of the slide out in a trailer frame.

FIG. 1A is a detail of FIG. 1.

FIG. 2 is a side view of the slide-out.

FIG. 3 is an end view of the slide out.

FIG. 4 is a lower perspective detail from FIG. 1.

FIG. 5 is a top plan view of the slide out.

FIG. 6 is a perspective view of the slide out in a trailer frame.

FIG. 7 is a detail of the holes in each slide rail.

### DETAILED DESCRIPTION OF THE PREFERRED EMBODIMENT

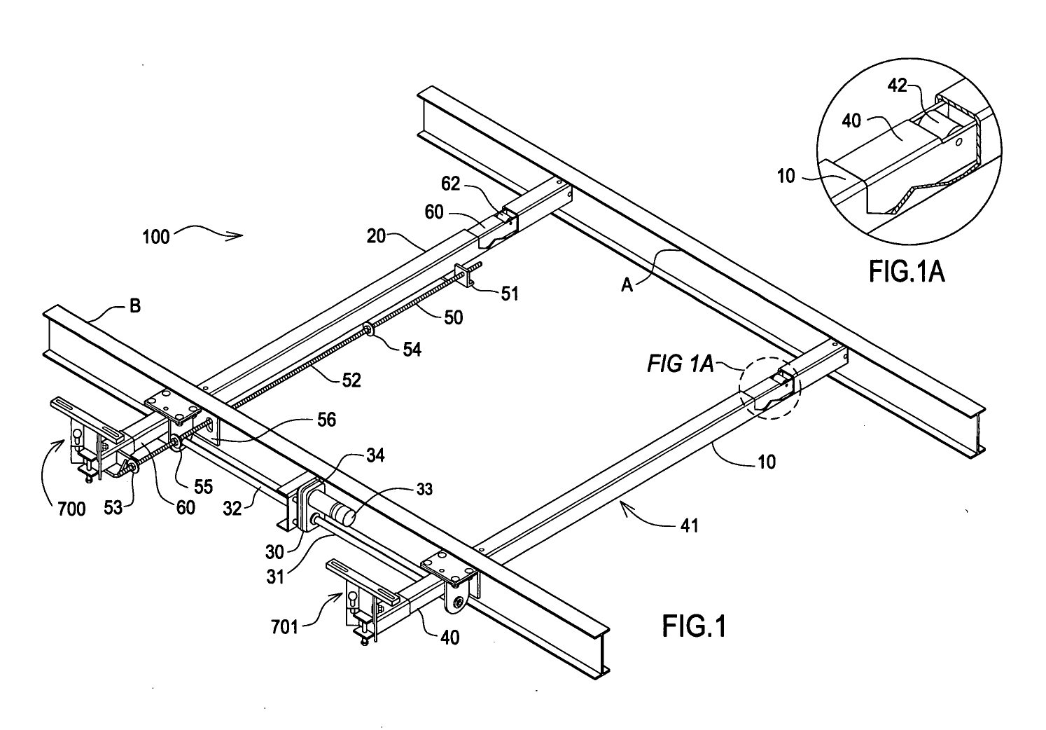

FIG. 1 is a perspective view of the slide out in a trailer frame. A pair of outer slide channels 10, 20 is welded or fastened using screws or bolts between trailer frame members A and B. Each channel 10, 20 projects through frame member B and has an end fastened to frame member A. Each channel has a “U” shaped cross section.

Each inner slide rail 60, 40 is nested within each slide channel 20, 10 respectively. Each slide rail has a rectangular cross section.

Motive member 30 extends and retracts each inner slide rail 60, 40. Motive member 30 comprises an electric motor 33 and transmission 34. Two half shafts 31, 32, connect the transmission to a cog drive engaged with each slide rail 60, 40.

A movement limiter 50 is engaged with one end of slide rail 60. A guide plate 51 is connected to slide rail 60. Another guide plate is connected to the other end of the slide rail 60. A threaded rod 52 is connected between the guide plates 51, 53.

An extend stop 54 is attached to the threaded rod 52. A retract stop 55 is also attached to the threaded rod 52. Each extend stop and retract stop comprise two jam nuts that lock a washer between them on the threaded rod. The extend stop and the retract stop each contact a stop plate 56 at each end of travel for the slide rail 60. When either stop contacts the stop plate an over-torque situation is created in the motive member, thereby causing it to stop operating.

A lower portion of a moveable room floor attaches to frame member 700 and frame member 701.

FIG. 1A is a detail of FIG. 1. Inner slide rail 40 is shown engaged within channel 10. Roller 42 engages an inner surface of channel 10 to facilitate movement of slide rail 40.

In a like manner an inner slide rail 60 is shown engaged within channel 20 in FIG. 1. Roller 62 engages an inner surface of channel 20 to facilitate movement of slide rail 60.

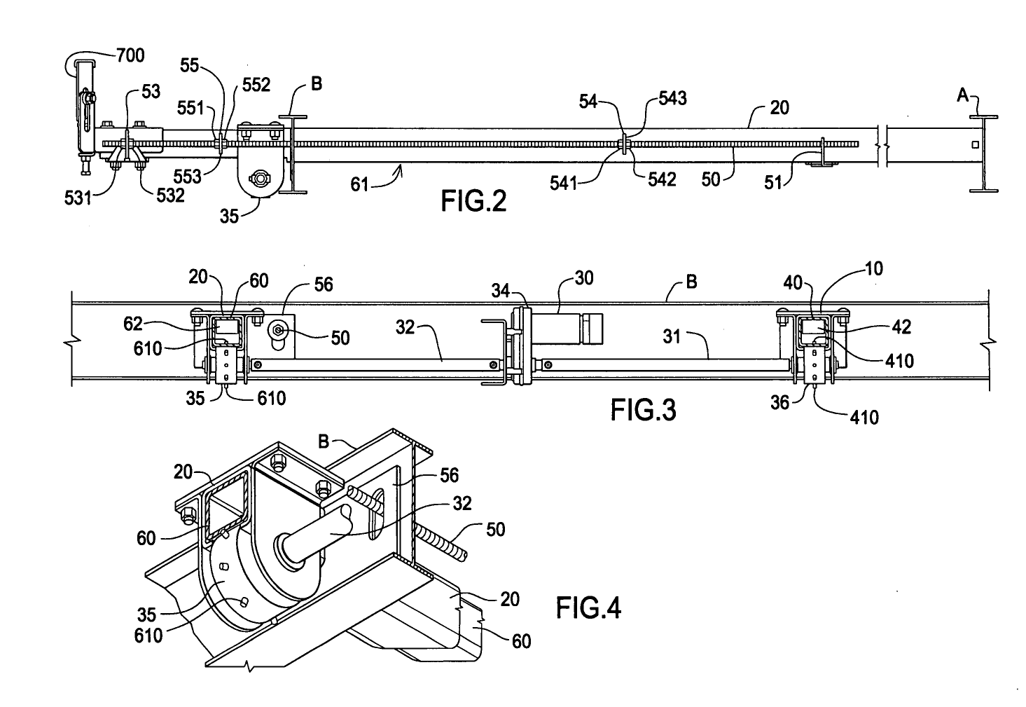

FIG. 2 is a side view of the slide-out. Stop 54 comprises a first jam nut 541, a second jam nut 542 and a washer 543 held therebetween. Stop 55 comprises a first jam nut 551, a second jam nut 552 and a washer 553 held therebetween.

During initial assembly, the position of stop 54 and stop 55 are each preset at an initial location on the threaded rod 50. The stop positions are adjusted from the side of the trailer in the following manner: The extend stop (54) is positioned by loosening the jam nuts 531, 532 and the entire threaded rod 50 is moved axially by sliding through holes in the guide plates 51 and 53. When the extend stop (54) is in the proper location, the jam nuts 531, 532 are then re-tightened against the guide plate 53. To adjust the location of the retract stop (55), the two jam nuts are loosened and moved by threading (turning) to the correct location on the threaded rod. Once at the correct location, the jam nuts (551,552) are tightened to secure the stop washer (553) into place.

A cog wheel 35 and projections 610 is in meshing engagement with the slide rail 60, namely, with a row of holes 61 running the length of and disposed along the bottom surface of rail 60, see FIG. 7. Cog wheel 35 is attached to half shaft 32.

FIG. 3 is an end view of the slide out. Half shaft 32 is connected to a cog wheel 35. Half shaft 31 is connected to a cog wheel 36.

A cog wheel 36 and projections 410 is in meshing engagement with the slide rail 40, namely, with a row of holes 41 running the length of and disposed along the bottom surface of rail 40, see FIG. 7. Cog wheel 36 is attached to half shaft 31.

A roller 42 is disposed at an end of the slide rail 40 opposite cog wheel 36. A roller 62 is disposed at an end of slide rail 60 opposite cog wheel 35. Each roller 42, 62 rolls along an inner surface of channel 10, 20 respectively as the slide out extends and retracts.

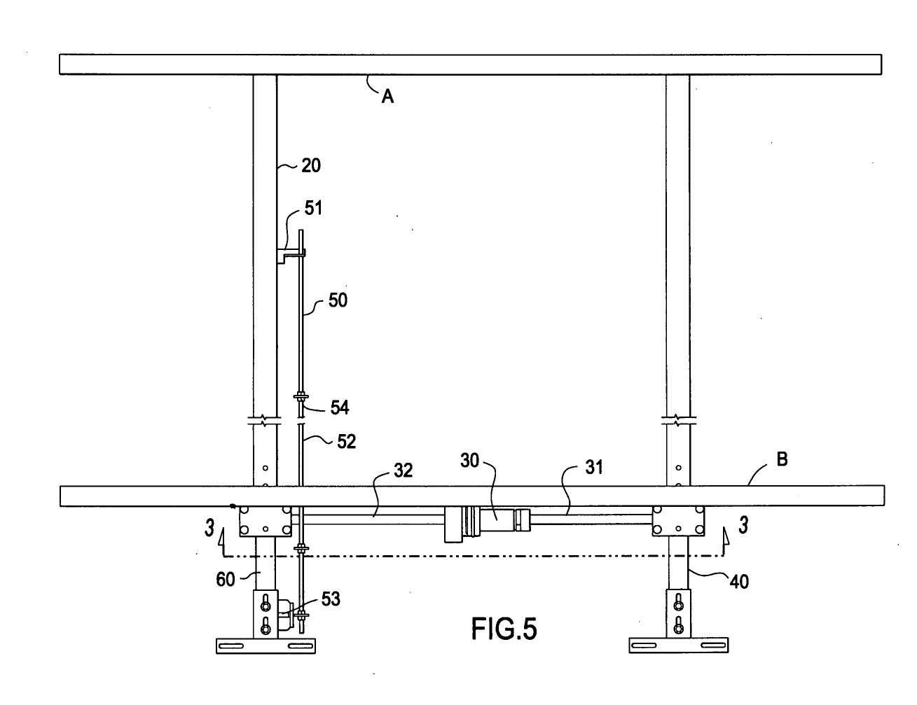

FIG. 4 is a lower perspective detail from FIG. 1. Half shaft 32 drives cog wheel 35. Each cog pin 610 engages a hole 61 in rail 60, see FIG. 7. In a like manner a half shaft 31 drives cog wheel 36. Each cog pin 410 engages a hole 41 in rail 40, see FIG. 7.

FIG. 5 is a top plan view of the slide out.

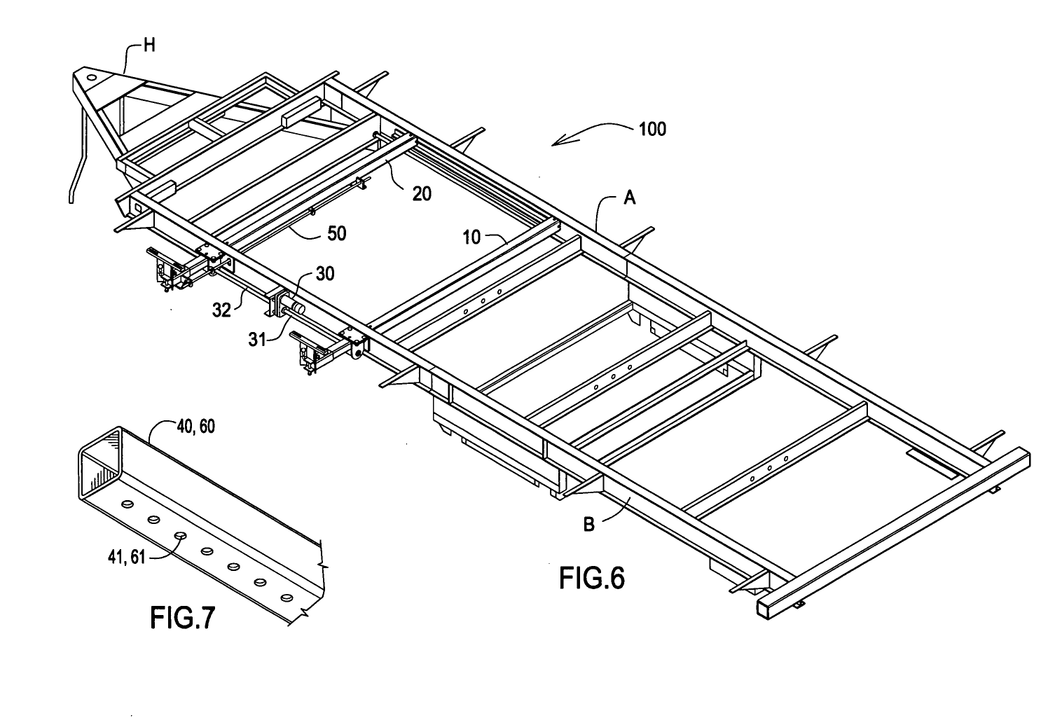

FIG. 6 is a perspective view of the slide out in a trailer frame. The frame comprises frame members A and B, each of which is connected to a hitch H. The slide out is disposed between each frame member A and B. The slide out may be fastened into the frame by welding or by using screws or bolts. Due to the advantageous adjustment method, the stop position for the slide out room may be adjusted from the side of the trailer instead of crawling under the trailer to make an adjustment.

Although a form of the invention has been described herein, it will be obvious to those skilled in the art that variations may be made in the construction and relation of parts and method without departing from the spirit and scope of the invention described herein.

I claim:

1. A vehicle slide out comprising:
a pair of first members mountable parallel to each other within a towed vehicle frame;
a pair of second members, each cooperatively engaged with a respective first member, each second member having a plurality of holes disposed lengthwise along a side;
a motive member serially engageable with the plurality of holes;
a threaded member connected to the second member and having a proximal threadably adjustable first stop and a distal threadably adjustable second stop, a position of the first stop and the second stop adjustable by an adjuster disposed at a proximal end of the threaded member; and
the first stop and the second stop disposed to contact the towed vehicle frame.

2. The vehicle slide out as in claim 1, wherein the first members comprise a channel cross-sectional form.

3. The vehicle slide out as in claim 1, wherein the second members comprise a rectangular cross-sectional form.

4. The vehicle slide out as in claim 1, wherein the motive member is engaged to the second member by a cog wheel.
